(19) United States
(12) Patent Application Publication
(10) Pub. No.: US 2025/0008194 A1
(43) Pub. Date: Jan. 2, 2025

(54) DISPLAY DEVICE, DISPLAY DEVICE COORDINATION SYSTEM, AND AUDIO PLAYBACK METHOD

(71) Applicant: MAXELL, LTD., Kyoto (JP)

(72) Inventors: Satoru TAKASHIMIZU, Kyoto (JP); Hiroshi CHIBA, Kyoto (JP); Mitsunobu WATANABE, Kyoto (JP); Kenji KASAI, Kyoto (JP); Takafumi WATANABE, Kyoto (JP)

(21) Appl. No.: 18/705,732

(22) PCT Filed: Nov. 5, 2021
(86) PCT No.: PCT/JP2021/040786

§ 371 Date: Apr. 29, 2024

(51) Int. Cl. H04N 21/81; G06F 3/16; H04N 21/41; H04N 21/4363; H04N 21/6405

(52) U.S. Cl. CPC H04N 21/8106; G06F 3/165; H04N 21/43637; H04N 21/6405; H04N 21/4131

(57) ABSTRACT

A display device for directly transmitting and receiving an audio signal to and from an audio signal receiving device by wireless communication without causing the audio signal to pass through a relay device, comprises a wireless communication unit, a display, and a controller configured to control the wireless communication unit and the display, wherein the wireless communication unit transmits a plurality of types of audio signals by multicast or broadcast wireless communication, and the plurality of types of audio signals is provided with incidental information indicating at least types of the audio signals, respectively.

### TECHNICAL FIELD

The present invention relates to a display device, a display device coordination system, and an audio playback method.

### BACKGROUND ART

Digital audio and video equipment such as digital TVs, smartphones, tablet terminals, and Bluetooth (registered trademark) speakers are widely available. For coordination of these devices, wireless communication such as Wi-Fi (registered trademark) and Bluetooth (registered trademark) is used to enhance the flexibility of audio signal transmission.

For example, Patent Literature 1 discloses “a wireless transmission system comprises a wireless source device for wirelessly transmitting AV contents and a plurality of sink devices for playing the AV contents that have been wirelessly transmitted. A bridge device receives a control command as a representative wireless sink device if the control command that has been wirelessly transmitted from the wireless source device is provided with a group identification ID of its own, and converts a wireless control command to be transmitted and received to and from the wireless source device and a wire control command transmitted and received to and from the sink devices to each other to communicate with other sink devices within the group. Furthermore, the bridge device wirelessly communicates with wireless source devices and representative wireless sink devices of other groups as a representative of the group to which the representative wireless sink device belongs (excerpted from Abstract).

### CITATION LIST

### Patent Literature

Patent Literature 1: JP-A-2010-279072

### SUMMARY OF INVENTION

### Technical Problem

In the conventional audio transmission technologies, one-to-one communication using Bluetooth (registered trademark) or Wi-Fi (registered trademark) has been employed, and thus transmission to a plurality of devices simultaneously and efficiently has not been a common technique. Accordingly, in the conventional technologies when a plurality of persons watches the content on the same display device such as a television device, each of the persons cannot simultaneously listen to different audio signals.

The present invention has been made in view of the circumstances described above, and an object of the present invention is to provide a display device, a display device coordination system, and an audio playback method, which increase the convenience and functionality for the case where a plurality of persons views the same video.

### Solution to Problem

In order to solve the problems described above, the present invention includes the features according to the scope of claims. One of the aspects of the present invention is a display device for directly transmitting and receiving an audio signal to and from an audio signal receiving device by wireless communication without causing the audio signal to pass through a relay device, comprising: a wireless communication unit; a display; and a controller configured to control the wireless communication unit and the display, wherein the wireless communication unit transmits a plurality of types of audio signals by multicast or broadcast wireless communication, and the plurality of types of audio signals is provided with incidental information indicating at least types of the audio signals, respectively.

### Advantageous Effects of Invention

According to the present invention, it is possible to provide a display device, a display device coordination system, and an audio playback method, which increase the convenience and functionality for the case where a plurality of persons views the same video. The objects, configurations, and advantageous effects other than those described above will be clarified by the explanation of the embodiments below.

### BRIEF DESCRIPTION OF DRAWINGS

FIG. 1 is a functional block diagram of a TV according to the present embodiment.

FIG. 2 illustrates an outline of a TV coordination system according to the first embodiment.

FIG. 3 illustrates an exemplary UI of a TV that is a source of multicasting or broadcasting.

FIG. 4 illustrates an outline of a TV coordination system according to the second embodiment.

FIG. 5 illustrates an outline of a TV coordination system according to the third embodiment.

FIG. 6 is a sequence diagram illustrating a flow of processing according to the third embodiment.

FIG. 7 illustrates an outline of a TV coordination system according to the fourth embodiment.

FIG. 8 illustrates an outline of a TV coordination system according to the fifth embodiment.

FIG. 9 illustrates an outline of a TV coordination system according to the fifth embodiment.

FIG. 10 illustrates an outline of a TV coordination system according to the sixth embodiment.

FIG. 11 illustrates an outline of a TV coordination system according to the seventh embodiment.

FIG. 12 illustrates an outline of a TV coordination system according to the eighth embodiment.

FIG. 13 illustrates an outline of a TV coordination system according to the ninth embodiment.

FIG. 14 illustrates an outline of a TV coordination system according to the tenth embodiment.

FIG. 15 illustrates an outline of a TV coordination system according to the tenth embodiment.

FIG. 16 is a sequence diagram illustrating a flow of processing of a TV coordination system.

### DESCRIPTION OF EMBODIMENTS

The present invention, from which diversification and technological improvements can be expected for labor-intensive industries, contributes to, for example, 8.2 “Achieve higher levels of economic productivity through diversification, technological upgrading and innovation, including through a focus on high-value added and labor-intensive sectors” of SDGs (Sustainable Development Goals) proposed by the United Nations. Hereinafter, exemplified embodiments of the present invention will be described with reference to the drawings. Throughout the drawings, the same components are provided with the same reference signs, and repetitive explanation therefor will be omitted.

HDMI, Bluetooth, and Wi-Fi used herein are registered trademarks, respectively.

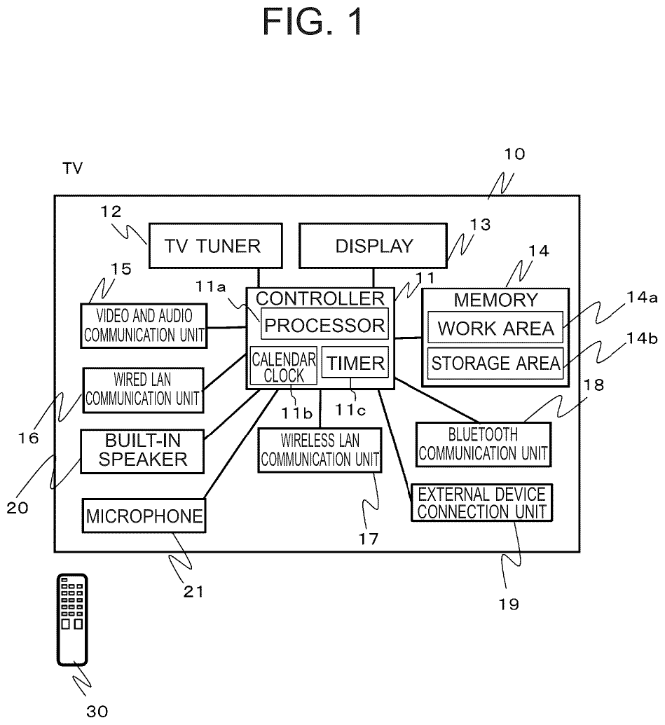

FIG. 1 is a functional block diagram of a television device (TV 10) that is a display device according to the present embodiment.

The TV 10 is configured with a TV tuner 12, a display 13, a memory 14, a video and audio communication unit 15, a wired LAN communication unit 16, a wireless LAN communication unit 17, a Bluetooth communication unit 18 (corresponding to the first wireless communication unit), an external device connection unit 19, a built-in speaker 20, and a microphone 21, which are connected to a controller 11.

The controller 11 includes a processor 11a for controlling the whole operations of the TV 10 in accordance with a predetermined program, a calendar clock 11b, and a timer 11c, thereby enabling timing-control in outputting audios and displaying videos.

The memory 14 includes a work area 14a and a storage area 14b. The work area 14a temporarily retains programs during execution of a basic operation program and other application programs, and also retains data as needed during execution of various application programs. The storage area 14b retains the stored information such as various setting values, various programs, movie data, and the like, even after supplied power is removed.

For the work area 14a, a volatile memory such as a RAM (Random Access Memory) is used.

For the storage area 14b, a non-volatile storage device such as a flash ROM, an SSD (Solid State Drive), or an HDD (Hard Disc Drive) is used.

Enhancement of the functions of the TV 10 can be realized by downloading a new application program from an application server via the Internet. At this time, the downloaded new application program is stored in the storage area 14b. In the following embodiments, it is assumed that the controller 11 loads the new application program stored in the storage area 14b on the work area 14a and executes the loaded new application program so as to realize the new functions of the TV 10.

The display 13 is a display device such as a liquid crystal panel or an organic EL display. The TV tuner 12 receives broadcast radio waves received via an antenna and carries out the video processing on them, and the display 13 displays the images and the like thus obtained.

The TV tuner 12 includes a terrestrial digital tuner, a BS/CS digital tuner, an OFDM demodulator, an MPEG decoder, and the like.

The processor 11a processes a multilingual broadcast such as a broadcast with two different languages received by the TV tuner 12, which allows the TV 10 to realize the functions of selecting one of the languages and outputting it via a speaker, or simultaneously outputting both the languages. In addition, the TV 10 has the function of simultaneously outputting a plurality of broadcast programs.

The video and audio communication unit 15 and an external device or the like is connected one-to-one with each other. The “external device” referred herein is a device configured to transmit or receive a non-compressed video signal to and from the TV 10 using, for example, an HDMI or the like. The video and audio communication unit 15 may be any type, for example, a personal computer (including a gaming PC which will be described later), a projector, or a home theater device.

The wireless LAN communication unit 17 transmits and receives data to and from wireless communication devices such as a smartphone 51 and a tablet, and can also be connected to the Internet via an access point.

The wired LAN communication unit 16 is connected to the Internet via a home gateway, and transmits and receives data to and from a server. The wired LAN communication unit 16 is connected to an STB (Set Top Box), and receives broadcast signals of a cable broadcast, a satellite broadcast, a terrestrial television broadcast, and an IP broadcast (broadband services, VOD services, and the like) from the STB.

The Bluetooth communication unit 18 communicates, using Bluetooth, with Bluetooth-enables audio signal receiving devices (Bluetooth terminals) such as the smartphone 51, a tablet, a Bluetooth speaker, and wireless earphones. Providing a plurality of antennas enables diversity and detection of the arrival direction of radio waves.

The Bluetooth communication unit 18 supports a multicast protocol and a broadcast protocol, and wirelessly transmits and receives a multicast audio signal and a broadcast audio signal (two-way communication). The Bluetooth communication unit 18 also receives signals from a plurality of Bluetooth terminals. In the present embodiment, Bluetooth Low Energy is used as a communication system enabling simultaneous Bluetooth communication among the TV 10 and a plurality of Bluetooth terminals.

Broadcasting does not require a pairing process in advance, which provides ease of use. On the other hand, multicasting requires registration of an audio signal receiving device in advance, which decreases the convenience as compared with broadcasting, however, it instead ensures the security and privacy.

Carrying out the audio communication by multicasting or broadcasting enables efficient one-to-many or many-to-many communication, which can reduce the power necessary for the communication and the used band of radio waves as compared with the one-to-one communication. In the following, multicasting will be described as an example, however, the same operations and effects can be obtained if using broadcasting instead of multicasting.

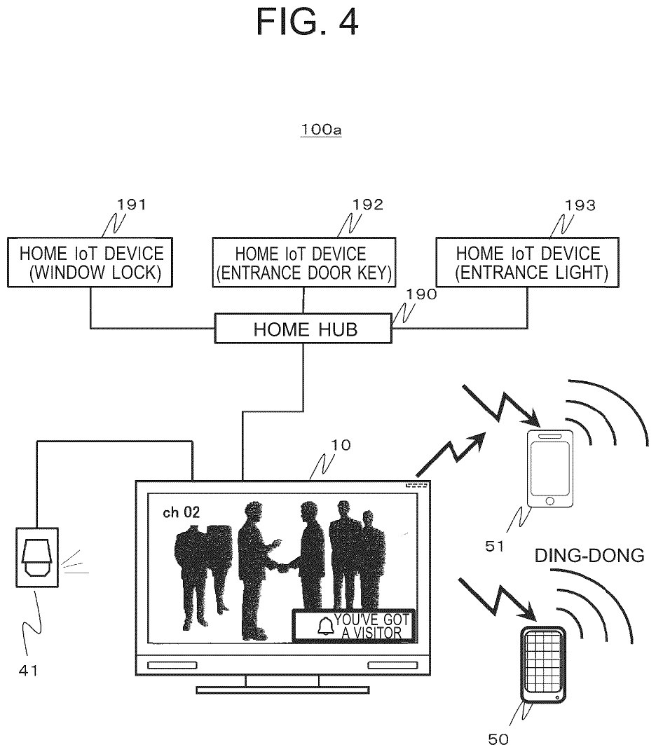

The external device connection unit 19 exchanges signals with a device such as a home hub 190 (see FIG. 4). The external device connection unit 19 may employ an independent wired connection, and alternatively, employ together with a network connection using the wireless LAN communication unit 17 or the Bluetooth communication unit 18.

The built-in speaker 20 outputs an audio from the TV 10.

The microphone 21 can capture an external audio into the TV 10. This enables audio operations and calls through the Internet.

Upon accepting an operation input from a user, a remote controller 30 transmits the input information to the TV 10. This allows the user to remotely operate the TV 10. The remote controller 30 is an example of the operation member.

### First Embodiment

The first embodiment relates to a TV coordination system 100 in which the TV 10 transmits a plurality of types of audio signals by multicasting or broadcasting, and each of the plurality of audio signal receiving devices individually selects any of the audio signals of the plurality of types and outputs an audio. In the present embodiment, Bluetooth Low Energy is used as a wireless communication standard between the TV 10 and the audio signal receiving device. Accordingly, hereinafter, an “audio signal receiving device” will be referred to as an LE-Audio terminal. In the embodiments which will be described later, smart speakers 50, 50a, 50b, the smartphone 51, a tablet, and wireless earphones 81, 82 are exemplified as specific examples of LE-Audio terminals, however, the LE-Audio terminals may be any type as long as they are capable of wireless communication using the Bluetooth Low Energy standard and audio playback, for example, they may be wireless headphones, gaming machine terminals, and the like.

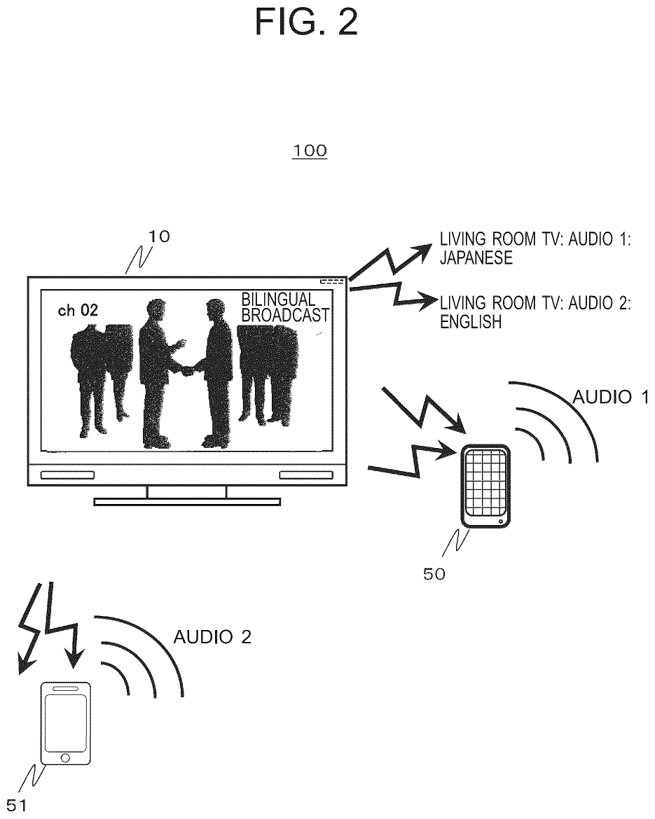

FIG. 2 illustrates an outline of the processing by the TV coordination system 100 according to the first embodiment.

The TV coordination system 100 is the system for directly transmitting and receiving audio signals with the TV 10, the smart speaker 50, and the smartphone 51, respectively, by wireless communication without causing the audio signals to pass through a relay device.

The TV 10 receives a broadcast signal of a bilingual broadcast, displays a video on the display 13, and outputs an audio through the built-in speaker 20. The TV 10 wirelessly transmits an audio signal of Japanese language and an audio signal of English language by multicasting or broadcasting, respectively.

The multicast signal or broadcast signal wirelessly transmitted from the TV 10 by multicasting or broadcasting include an audio signal of the broadcast to be played by the TV 10. Furthermore, the multicast signal or broadcast signal is provided with incidental information including the name of the transmitting device that is “living room TV” and language information included in the multilingual broadcast signal, for example, which indicates “Japanese” or “English”.

The TV 10 can also transmit a signal having the content which is the same as that of the multicast signal by broadcasting. In this case, the TV 10 can output an audio to an audio signal receiving device regardless of the setting of the TV 10 as long as the audio signal receiving device selected to receive a broadcast signal. In order to simplify the description, in the following, the case where the TV 10 transmits a multicast signal will be described, however, the same operations and effects can be obtained if a “broadcast signal” is transmitted instead of a multicast signal.

The TV 10 encodes (encrypts) and transmits the multicast signal so that the LE-Audio terminals capable of receiving it can be limited.

For example, the smart speaker 50 is set in advance so as to preferentially output an audio in Japanese. Upon receiving a multicast signal from the TV 10, the smart speaker 50 selects an audio signal of Japanese language included in the multicast signal and plays an audio. On the other hand, the smartphone 51 is set so as to output an audio in English, and upon receiving a multicast signal from the TV 10, the smartphone 51 selects an audio signal of English language included in the multicast signal and plays an audio.

Thus, the TV 10 simultaneously transmits a plurality of audios when broadcasting multilingual, multi-channel audios. The LE-Audio terminal refers to the incidental information and appropriately selects an audio signal to play (output) an audio. The incidental information may include the names of channels (front right, front left, center, rear right, rear left) of a multi-channel audio. This enables, for example, playback of 5.1-channel surround sound using a plurality of Bluetooth speakers.

As described above, the TV 10 wirelessly transmits audio signals of a plurality of types by multicasting, and an LE-Audio terminal appropriately selects a necessary audio signal included in the multicast signal, so that each different LE-Audio terminal can output a desired audio.

### (Setting UI of TV 10)

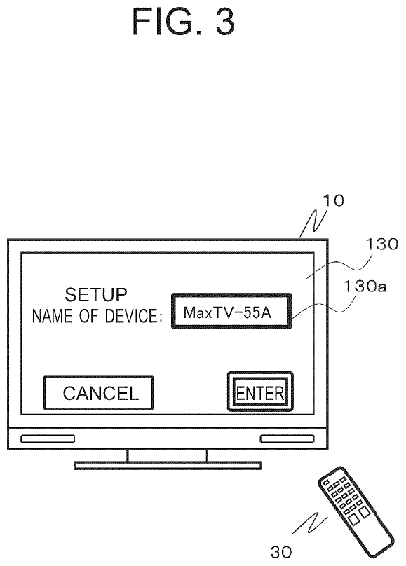

FIG. 3 illustrates an exemplified UI of the TV 10 which is a transmission source of multicasting or broadcasting.

The controller 11 of the TV 10 displays a setting window 130 for setting a setting name (corresponding to the name of a transmitting device) of the TV 10 on the display 13. The setting window 130 is provided with a registration field 130a for registering the name of the TV 10. A user can set the setting name of the TV 10 such as “Living room TV”, “Bedroom TV”, or the like using the remote controller 30. This setting operation may be performed using a menu operation or a text input operation by means of the remote controller 30.

The setting name of the TV 10 which has been entered is added to a multicast signal as the name of a transmitting device. This allows an LE-Audio terminal, even if it has received multicast signals from a plurality of TVs, to identify which transmitting device transmitted the audio signal, which makes it easy for the LE-Audio terminal to select a signal.

### Second Embodiment

The second embodiment is the embodiment in which a gateway function of an LE-Audio terminal is implemented in the TV 10 of a TV coordination system 100 according to the first embodiment.

FIG. 4 illustrates an outline of the TV coordination system 100a according to the second embodiment.

In FIG. 4, a doorbell 41 installed at the entrance is connected to the external device connection unit 19 of the TV 10 by wire or wirelessly. Upon receiving a signal from the doorbell 41, the TV 10 creates an audio signal corresponding thereto, and wirelessly transmits it to an LE-Audio terminal by multicasting. At the same time, an audio of this signal may be output through the built-in speaker 20 of the TV 10.

The audio signal to be output in this case may be the sound of a bell such as “ding-dong”, or the voices such as “you've got a visitor” may be provided using a synthesized or recorded audio.

The external device connection unit 19 may be directly connected to the doorbell by wire or wirelessly, or may be connected via the home hub 190.

In FIG. 4, home IoT devices 191, 192, 193 are further connected to the TV 10 via the home hub 190. Via the home hub 190, the TV 10 may multicasts the signals obtained from the home IoT devices 191, 192, 193 to the LE-Audio terminal, for example, the smart speaker 50 or the smartphone 51. In FIG. 4, the home IoT device 191 is a window lock, the home IoT device 192 is an entrance door key, and the home IoT device 193 is an entrance light. The window lock and the entrance door key are ones of the examples of household equipment, and the entrance light is one of the examples of home electric appliance.

The multicast signals include a notification signal for notifying whether the door has been locked, an interactive signal to be transmitted when a visitor pushes a button of a doorbell connected to the TV 10, and the like. In the case described above, if the smart speaker 50 or the smartphone 51 was outputting an audio of a TV program when having received a multicast signal from the home hub 190 or the like, for example, lowering the audio volume of the TV program or temporarily stopping the output can cause the output of the audio based on the multicast signal received from the home hub 190 or the like to be easily heard.

Furthermore, it may be configured such that, when the TV 10 is operated at night to turn off the power, the home hub 190 may be used to confirm whether the door was locked, and an audio for alert is output if the door was not locked. In this case, a message may be simultaneously displayed on the screen of the display 13.

On the user side, inputting an audio command to lock the door or turn off the light using the LE-Audio terminal causes the LE-Audio terminal to transmit an audio signal to the TV 10. The TV 10 analyzes the audio signal and converts it into a control signal to be transmitted to each of the home IoT devices 191, 192, 193. Then, the TV 10 may transmit the control signal to any of the home IoT devices 191, 192, 193 via the home hub 190 to cause it to lock the door or window or turn off the light such as the entrance light. At this time, an audio for confirmation such as “door will be locked” or “entrance light has been turned off” is sent by multicasting or broadcasting.

According to the present embodiment, a user uses the TV 10 and an LE-Audio terminal to carry out a control operation such as locking the door or window or turning off the light such as an entrance light by transmitting a control signal to any of the home IoT devices 191, 192, 193 located indoors at distance.

### Third Embodiment

The third embodiment is the embodiment, in which, in the TV 10 of the TV coordination system 100 according to the first embodiment, the timing of audio output from an audio signal receiving device connected to the TV 10 and the timing of audio output and video display from the TV 10 are adjusted to synchronize them with each other.

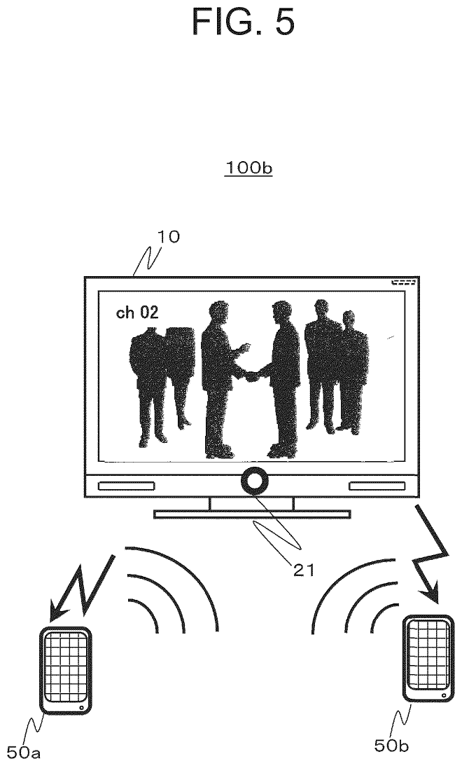

FIG. 5 illustrates an outline of a TV coordination system 100b according to the third embodiment.

The TV coordination system 100b takes a measure against delay between the TV 10 and an LE-Audio terminal. FIG. 5 exemplifies the smart speakers 50a, 50b as LE-Audio terminals.

In wireless transmission of an audio of a received TV broadcast or the like by broadcasting or multicasting, the audio may be simultaneously output from the plurality of smart speakers 50a, 50b. If the output timings of the audio are largely shifted with each other, the audio may be difficult to be heard. In order to prevent this, a delay time from reception of a signal to output of an audio is managed at each of the LE-Audio terminals to adjust the timings of displaying a video and outputting an audio on the TV 10. More specifically, it is managed by a method using, for example, wireless communication by broadcasting or multicasting and communication with individual devices in combination.

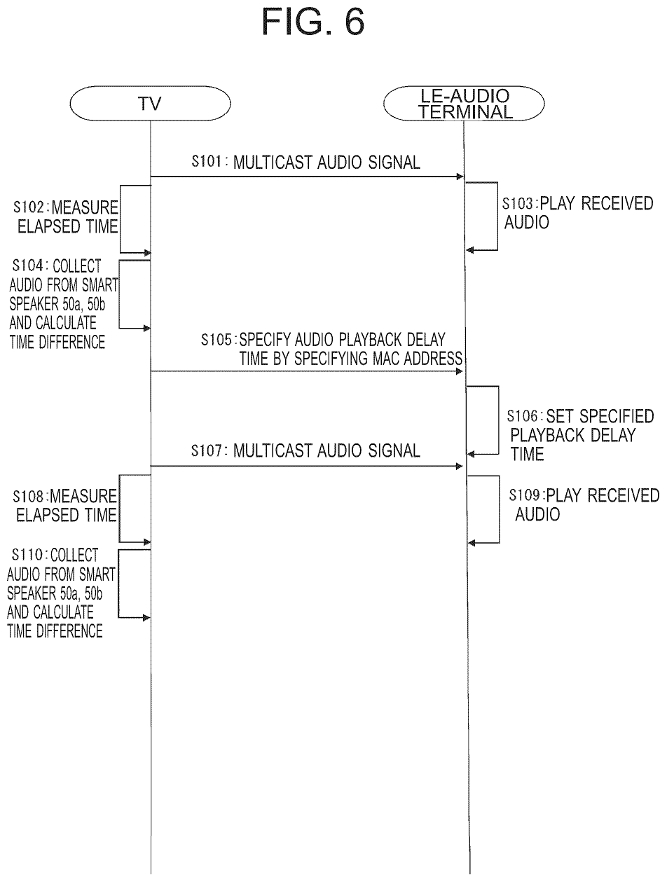

Referring to FIG. 6, a flow of processing for taking a measure against delay between the TV 10 and an LE-Audio terminal will be described. FIG. 6 is a sequence diagram illustrating a flow of the processing according to the third embodiment.

The TV 10 multicasts an audio signal (step S101) and measures an elapsed time from a time (t1) at that time using the timer 11c (step S102).

Each of the smart speakers 50a, 50b receives the multicast signal and plays (outputs) an audio (step S103).

The microphone 21 of the TV 10 collects audios V2a, V2b played by the smart speakers 50a, 50b, respectively (step S104). The controller 11 uses the timer 11c to measure times t2a, t2b at which each of the audios V2a, V2b was collected, and calculates a time difference Δt1 between the times t2a, t2b.

When the time difference Δt1 is more than a predetermined value tₜₕ, the TV 10 identifies the destination of transmission of information by specifying it based on a MAC address or identifying the destination based on the incidental information and transmit playback delay time information (step S105). The smart speaker 50a delays the time until it outputs the audio from receiving the multicast signal by Δt1 based on the received playback delay time information. Therefore, Δt1 corresponds to the playback delay time. More specifically, for example, the smart speaker 50a adjusts to delay the time until it outputs the audio signal obtained by receiving the multicast signal as the audio by Δt1 using the memory provided in the smart speaker 50a (step S106).

Next, the TV 10 multicasts an audio signal again (step S107) and measures an elapsed time from a time (t3) at that time using the timer 11c (step S108).

Each of the smart speakers 50a, 50b receives the multicast signal and plays (outputs) an audio (step S109).

The microphone 21 of the TV 10 collects the audios V2a, V2b played by the smart speakers 50a, 50b, respectively, and the controller 11 measures times t4a, t4b at which each of the audios V2a, V2b was collected by the timer 11c, and calculates a time difference Δt2 between the times t4a, t4b (step S110).

When Δt2 is equal to or less than the predetermined time tₜₕ, the delay time difference adjustment processing is ended.

On the other hand, when Δt2 is more than the predetermined time tₜh, the smart speaker 50a is controlled in the same manner as described above to restore the playback delay time Δt1 set in the step above to 0, and the smart speaker 50b is controlled by carrying out the processes starting from step S101 in the same manner as described above to delay the time until the smart speaker 50b outputs the audio from receiving the multicast signal by Atl. Then, the audio signal is transmitted by multicasting again, the audios V2a, V2b played based on the multicast signal received by each of the smart speakers 50a, 50b are collected, the times t2a, t2b at which the audios V2a, V2b were collected, respectively are measured, and the time difference Δt1 between the times t2a, t2b is calculated. Thus, the method as described so far enables adjustment of the timing of audio output from each of the smart speakers.

When the delay of the time until a video is displayed by the video signal processing carried out by the TV 10 is more than the delay of time until an audio is output from each of the smart speakers 50a, 50b, the delay time between the timing of wireless transmission by broadcasting or multicasting and the timing of audio output from the smart speakers 50a, 50b may be determined so that the timing of the video display and the timing of the audio output substantially match each other.

Furthermore, it may be configured such that the microphone 21 built in the TV is used to acquire an audio from each of the speakers so as to calibrate the delay time. This configuration does not require the processes from step S101 to step S109 for each adjustment but only delays displaying of a video signal by the time obtained by the calibration in step S105 after transmitting a multicast signal, which enables reduction of the computation load of the TV 10 and thus saving of the hardware resource.

Furthermore, it may be configured such that, if the delay time changes depending on the condition of wireless communication, the microphone 21 is used to detect the state in which the delay time has changed so as to correct the delay time. That is, for example, when it is detected that the delay time until an audio is output from each of the smart speakers 50a, 50b has changed, the TV 10 may transmit, to each of the smart speakers 50a, 50b, a signal for changing the delay time until it outputs an audio from receiving the audio signal in accordance with the method described above, or may temporarily interrupt the transmission of a multicast signal or broadcast signal and then resume the transmission to correct a deviation of the timings.

### Fourth Embodiment

The fourth embodiment is an embodiment in which the TV 10 of the TV coordination system 100 according to the first embodiment receives a multicast signal and plays it.

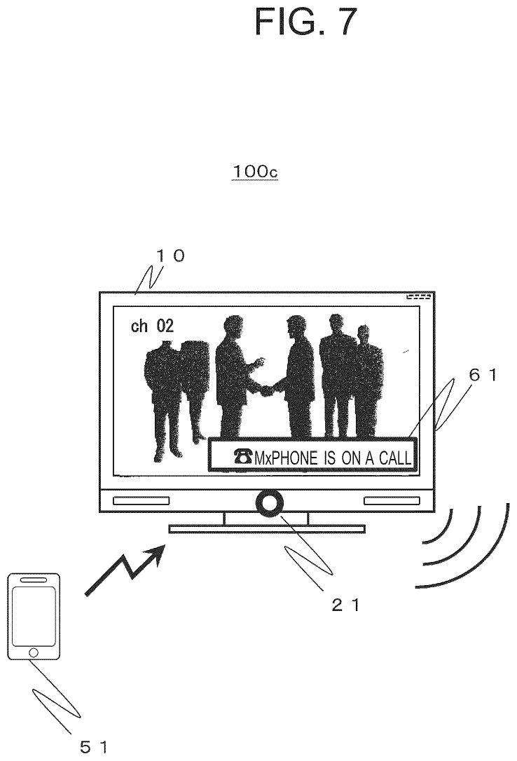

FIG. 7 illustrates an outline of a TV coordination system 100c according to the fourth embodiment. Upon receiving an incoming call, the smartphone 51 wirelessly transmits an audio of the call by multicasting or broadcasting, and the TV 10 receives it. The TV 10 is set in advance to receive a multicast signal from the predetermined smartphone 51.

Thus, for example, when the smartphone 51 starts transmitting the audio of the call by multicasting, the TV 10 receives it and outputs the received audio through the built-in speaker 20. At this time, for example, if the TV 10 is during reception of a broadcast, the audio may be mixed as appropriate and output, or an audio of the broadcast being received may be muted.

Furthermore, the device name of the smartphone 51, such as “Mx Phone”, and the text indicating the status thereof, such as “on a call”, may be displayed on the screen of the display 13 as a call status display 61 of the smartphone 51, so that a call status of an LE-Audio terminal being connected by wireless communication with the TV 10 can be viewed.

The present embodiment enables a user to make a call using the built-in speaker 20 of the TV 10 without performing a switching operation necessary in one-to-one communication between devices, which can improve the convenience and functionality.

### Fifth Embodiment

The fifth embodiment is an embodiment in which an interactive conversation between the TV 10 of the TV coordination system 100 according to the first embodiment and each of the audio signal receiving devices connected to the TV 10 is realized.

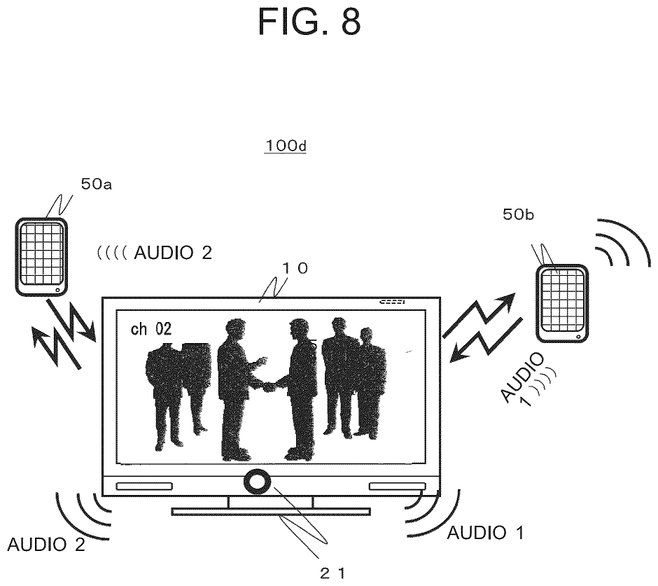

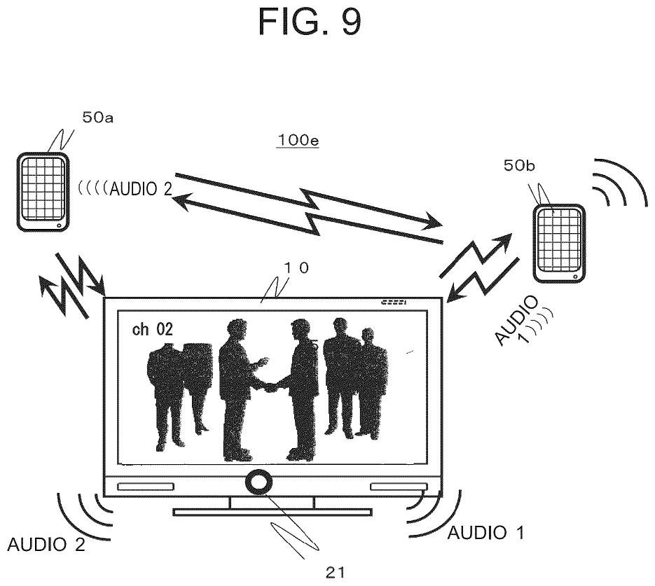

FIG. 8 illustrates an outline of a TV coordination system 100d according to the fifth embodiment. FIG. 9 illustrates an outline of a TV coordination system 100e according to the fifth embodiment, which differs from FIG. 8 in that the smart speakers 50a, 50b also interactively communicate with each other by multicasting.

FIG. 8 and FIG. 9 illustrate situations in which the smart speakers 50a, 50b each equipped with a microphone are interactively communicated with the TV 10 by multicasting, respectively.

In FIG. 8, the TV 10 and the smart speaker 50a, and the TV 10 and the smart speaker 50b are wirelessly connected to each other. By multicast communication from the TV 10, audios of callers using the smart speakers 50a, 50b are output through the speaker of the TV 10. Furthermore, the TV 10 relays an audio received from the smart speaker 50a to the smart speaker 50b, and also relays an audio received from the smart speaker 50b to the smart speaker 50a. This enables a call among three parties using the TV 10 and the smart speakers 50a, 50b, and can provide the function of an intercommunication system.

In FIG. 9, the smart speaker 50a and the smart speaker 50b are also wirelessly connected to each other. This also enables a conversation between the smart speakers 50a, 50b without relay of the TV 10.

Thus, the present embodiment enables three or more persons to freely participate in or leave a call without a central server to be installed to carry out mixing or switching audios. A call based on an intercommunication system by multicasting or broadcasting is not only carried out by the combination of the TV 10 and the smart speakers 50a, 50b, but also may be carried out by a combination of the TVs 10 on which the microphones 21 are mounted or a combination with the smartphone 51.

Furthermore, it may be controlled such that the localization of an audio changes depending on the position of a caller.

For example, in the case of a call involving a plurality of persons, the localization of thereof may be controlled in the TV 10 and the audios are output such that the audio of the first caller can be heard from the center, the audio of the second caller can be heard from the right, and the audio of the third caller can be heard from the left. This makes it easier to identify which caller has uttered. Pairing with LE-Audio terminals to be talked in advance enables identification of each of the LE-Audio terminals using MAC addresses or the like. Alternatively, it may be identified using the device name or the like included in incidental information of a multicast transmission signal.

Furthermore, the localization of each of the LE-Audio terminals may be fixed at a preset position. For example, it may be set in advance such that an audio from the smart speaker in the kitchen is heard from the left and an audio from the TV in the kid's room is heard from the right.

Still further, a plurality of Bluetooth antennae may be provided to determine the direction of a caller using the direction detection function, and the localization of the audio may be set so as to match the direction as determined. Note that the localization of an audio is not limited to simple distribution in the left and right, but can be set in a wider range using the techniques of surround sound, virtual surround sound, and the like.

### Sixth Embodiment

The sixth embodiment is an embodiment in which a setting window of each of the LE-Audio terminals is displayed on the display 13 of the TV 10 of the TV coordination system 100 according to the first embodiment to accept a setting operation.

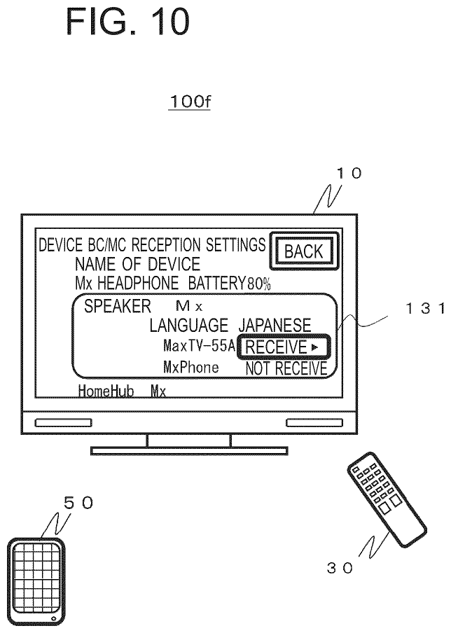

FIG. 10 illustrates an outline of a TV coordination system 100f according to the sixth embodiment.

In many cases, a Bluetooth device such as the smart speaker 50a does not have an interface for accepting complex operations and settings. In the present invention, as illustrated in FIG. 10, a setting window 131 of a Bluetooth device is displayed on the TV 10 to allow a multicast or broadcast signal to be selected so that the setting of the Bluetooth device can be performed by an operation using the remote controller 30 or the like.

The setting window 131 may be configured to display a list of Bluetooth devices being connected and allow a user to select a device to be set, select a priority order of a multicast or broadcast audio to be output by the device as selected, set whether a signal is to be received for each transmitting device, or select a language to be prioritized for an audio including multiple languages. In the setting window 131 of a battery-operated device, the state of charge of the battery may be displayed.

The setting window 131 displays the setting contents of the smart speaker 50a connected to the TV 10. The setting contents of the device having the name “speaker Mx” are displayed as follows:
(Language of audio to be played) Japanese has priority;
Receive multicast or broadcast signal from “MaxTV-55A”; and
Do not receive multicast or broadcast signal from “MxPhone”.

The setting window 131 as illustrated shows that a user is changing whether a signal from “MaxTV-55A” is to be received using the remote controller 30.

Thus, the present embodiment enables easy setting for each LE-Audio device using the TV 10 even if an UI such as a setting window of the LE-Audio terminal is not well-developed.

In the present embodiment, an LE-Audio terminal such as a smart speaker may store, as a reception history, the incidental information (for example, the name of a transmitting device, the type of an audio, and the like) of a multicast or broadcast signal received in the past, and transmit a list thereof to the TV 10. Upon receiving the list, the TV 10 sets whether to receive a signal and the priorities based on the information in the list, and transmits the setting content from the TV 10 to the LE-Audio terminal, whereby a desired setting can be realized.

Furthermore, for the purpose of improving the operability, it may be configured such that, in absence of transmission or reception of any broadcast or multicast signal, the TV 10 reads a connection history stored in the storage area 14b and displays a list of Bluetooth devices connected to the TV 10 on the setting window 131 so that the setting operations described above can be performed.

### Seventh Embodiment

The seventh embodiment is an embodiment in which each of the LE-Audio terminals sets whether to communicate with a new LE-Audio terminal using the display 13 of the TV 10 of the TV coordination system 100 according to the first embodiment.

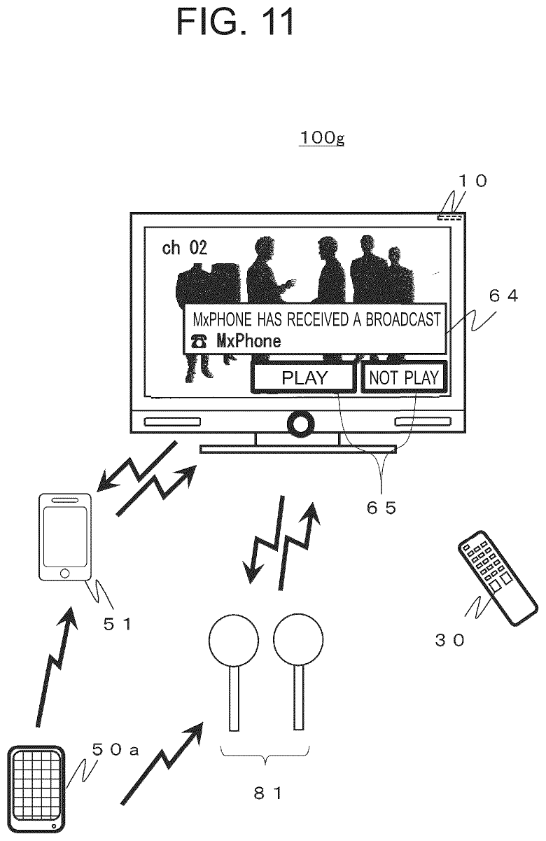

FIG. 11 illustrates an outline of a TV coordination system 100g according to the seventh embodiment.

In the embodiment illustrated in FIG. 11, an example in which a device receives a new multicast signal that has not been set will be described.

The smartphone 51 detects new broadcast communication from the smart speaker 50a which is an unknown Bluetooth device, and notifies the TV 10 that has been paired therewith of the detection. This notification may be provided by one-to-one communication, or by broadcasting or multicasting.

Upon receiving the notification, the TV 10 displays, on the display 13, a new device notification 64 for notifying that the smartphone 51 has detected new broadcast communication and a playback necessity button 65.

The new device notification 64 includes the device name “MxPhone” which has received a broadcast from the new device, and the text “having received a broadcast” which indicates the status thereof.

The playback necessity button 65 shows options of setting of whether the broadcast signal received by the “MxPhone” is to be played.

When a user makes a selection using the remote controller 30, the TV 10 transmits a necessary setting instruction to the smartphone 51 in accordance with the result of selection, for example, a control signal that causes the smartphone 51 to relay an audio signal of the smart speaker 50 and transmit it to the TV 10, or a control signal that does not cause the smartphone 51 to relay the audio signal of the smart speaker 50. This transmission may be carried out by multicasting or broadcasting from the TV 10. Upon receiving a multicast signal from the TV 10, the LE-Audio terminal interprets, for example, the Mac address included in the control signal, and discards the received control signal if it is not for the terminal itself.

Thus, the present embodiment enables a user to perform a setting operation for allowing or not allowing each of the LE-Audio terminals to communication with a new LE-Audio terminal on a screen of the TV 10.

Furthermore, it may be configured such that only a small indicator is displayed for a short time and the name of a broadcast device and whether a signal is to be received or not received are set separately by a menu-operation or the like so as not to hinder the display of the contents on the TV 10.

The indicator may be displayed on the screen, or may be notified by means of an LED outside the screen or the like.

In the description above, the example in which a Bluetooth device is the smartphone 51 has been described. Note that, for setting a device not having a well-developed UI, such as the smart speaker 50 or the wireless earphone 81, using the screen of the TV 10 increases the usability more and thus enhances the convenience.

For setting the smartphone 51 as well, using the screen of the TV 10 enhances the convenience since the setting thereof can be completed only using a TV screen which is being watched by a user and the remote controller 30.

### Eighth Embodiment

The eighth embodiment is an embodiment in which an exhibition mode suitable for in-store promotion is implemented in the TV 10 of the TV coordination system 100 according to the first embodiment.

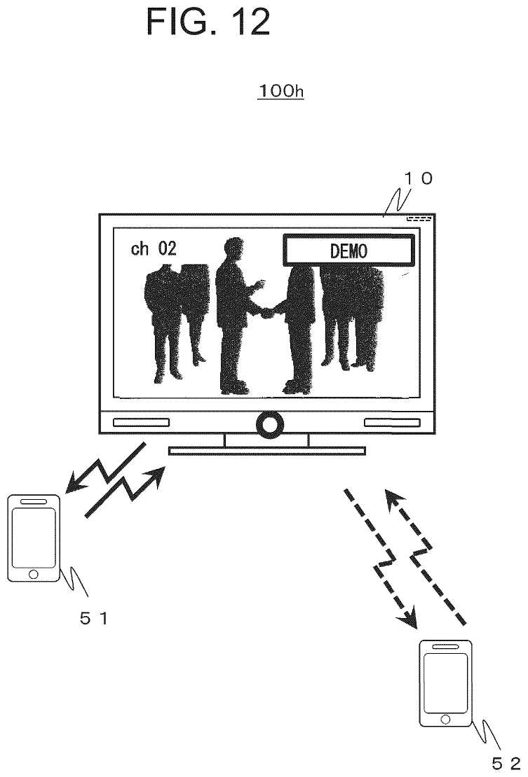

FIG. 12 illustrates an outline of a TV coordination system 100h according to the eighth embodiment.

In many cases, the TV 10 has an exhibition mode for in-store promotion as its function. In the exhibition mode of the TV 10 of the TV coordination system 100h, preferably, the TV 10 is paired with an LE-Audio terminal of a customer or set to receive a multicast signal so that the customer can actually experience the functions.

However, this may cause an unpreferable operation in which, after an LE-Audio terminal of a customer was connected to the TV 10, when other customers try to test the function relating to LE-Audio terminals according to the present embodiment, the TV 10 is connected to the LE-Audio terminal of the customer who tested the function immediately therebefore and thus an audio is output therefrom.

In order to prevent the unpreferable operation described above, in the exhibition mode, a pairing with the TV 10 is limited to a small number of devices. In the TV 10, when pairing with a new LE-Audio terminal 51 is set in the exhibition mode, the previous pairing setting is removed so as to prevent a signal transmitted by multicasting from being received by an LE-Audio terminal 52 that previously paired with the TV 10. More specifically, for example, the TV 10 may be configured to have at least two or more multicast groups so that, when pairing with a new LE-Audio terminal in the exhibition mode, the TV 10 can communicate with the multicast group different from the multicast group that was paired immediately therebefore. In this case, removing the setting of the multicast group used for the first communication can prevent the device connected in the past from being connected again.

The number of devices to be paired in the exhibition mode may be limited to one.

### Ninth Embodiment

The ninth embodiment is an embodiment in which, in the TV 10 of the TV coordination system 100 according to the first embodiment, a plurality of broadcast programs is simultaneously displayed on the screen of the display 13 that has been divided, respectively, and audio signals of the plurality of broadcasts are transmitted by multicasting, so that an LE-Audio terminal can selects any one of the audio signals of the plurality of broadcast programs and outputs an audio thereof. The audio signals of the plurality of programs are provided with audio channel name information, respectively.

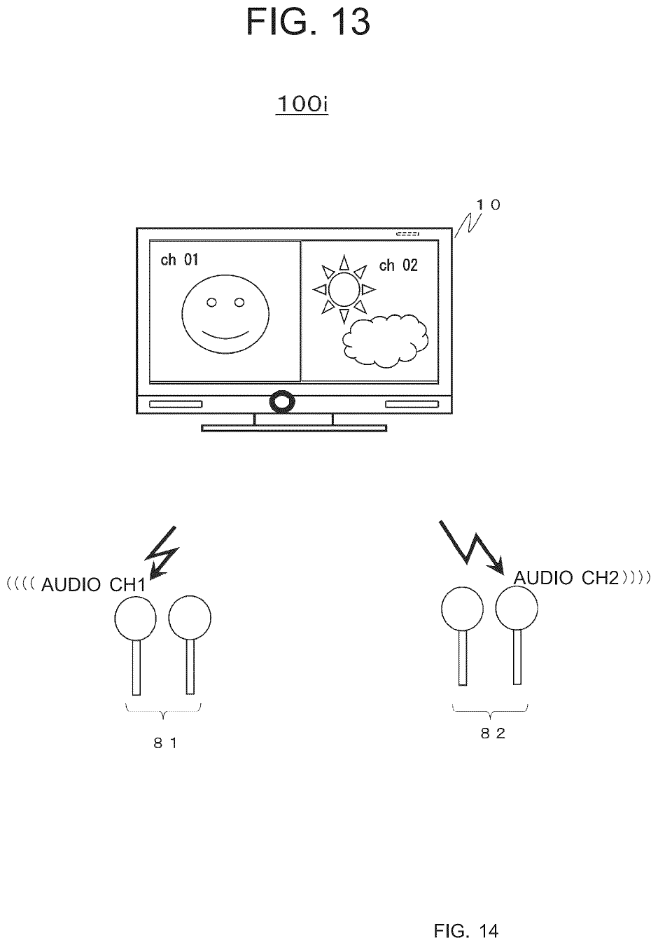

FIG. 13 illustrates an outline of a TV coordination system 100i according to the ninth embodiment.

The TV 10 is displaying two broadcast programs, Channel 1 and Channel 2. The TV 10 stops outputting audios through the built-in speaker 20 and multicasts the audio signals of Channel 1 and Channel 2, respectively.

Each of the wireless earphones 81, 82 receives both the audio signals of Channels 1, 2. Then, the wireless earphones 81 output the audio of Channel 1, and the wireless earphones 82 output the audio of Channel 2.

According to the present embodiment, if a plurality of programs is to be viewed on the single TV 10, the audios thereof can be selected by the wireless earphones 81, 82 and heard, which enables the plurality of programs to be viewed on the single TV 10 at the same timing.

### Tenth Embodiment

The tenth embodiment is an embodiment in which, in the TV 10 of the TV coordination system 100 according to the first embodiment, specific position audio signals which can be heard at a plurality of audio playback positions, respectively, are generated based on a 3D sound source, and the plurality of specific position audio signals is transmitted by multicasting or broadcasting.

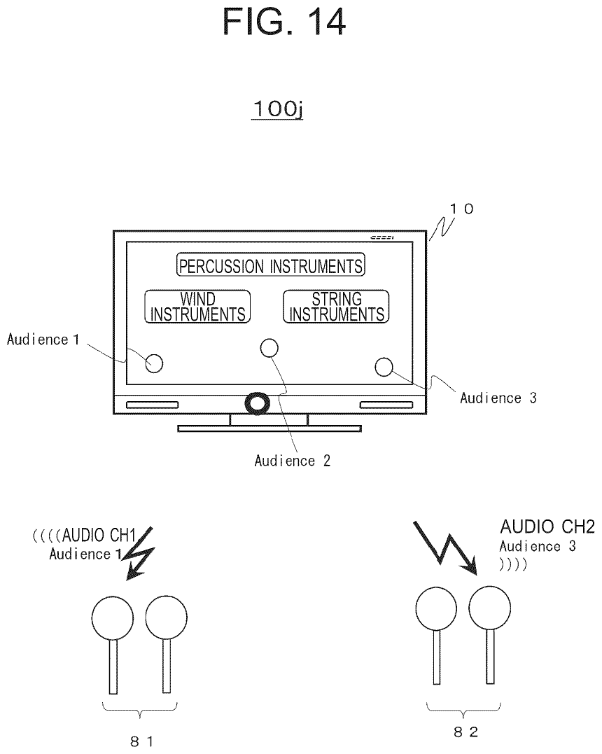

FIG. 14 illustrates an outline of a TV coordination system 100j according to the tenth embodiment.

In the TV coordination system 100j, the TV 10 generates three types of audio signals, which are the sounds heard by Audiences 1, 2, 3 who are assumed to be seated on the different positions, respectively, based on a performance by an orchestra recorded as a 3D sound source. Using the 3D sound source, a sound source signal is generated for each musical instrument, and the position and localization of the sound source are added to the audio signal as meta-data. Then, the sound source signals are combines with each other in accordance with the positions of Audiences 1, 2, 3, and specific position audio signals that play the sounds that can be heard at the positions, respectively, is generated.

The TV 10 multicasts or broadcasts the three types of specific position audio signals.

The wireless earphones 81, 82 output the audio signals of Audiences 1, 3, respectively.

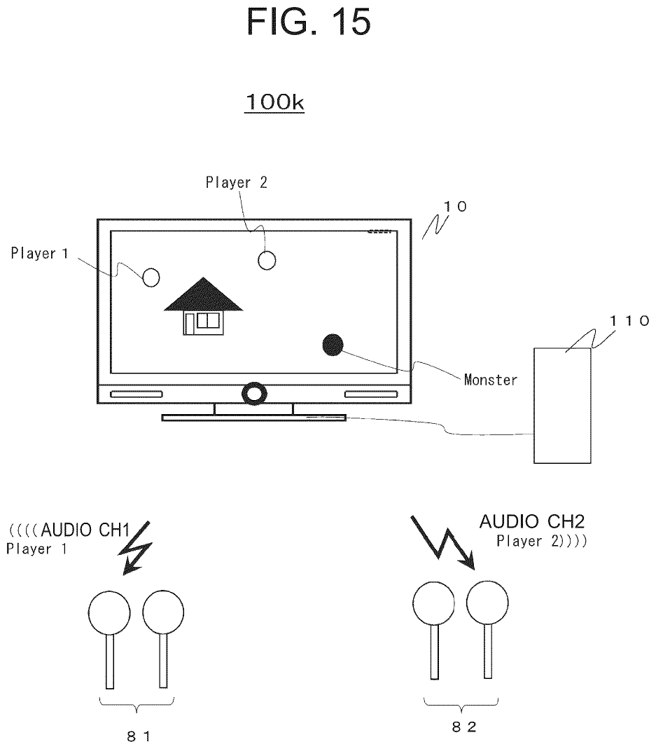

FIG. 15 illustrates an outline of a TV coordination system 100k according to the tenth embodiment.

In the TV coordination system 100k, the TV 10 and a PC 110 (for example, a gaming PC equipped with a GPU) are connected to each other using an HDMI, and the TV 10 is used as a monitor of the PC 110.

The TV 10 receives a video signal and audio signal of e-sports or live game streaming transmitted from the PC 110. In this case as well, it is assumed that the audio signal is generated based on a 3D sound source.

The TV 10 or the PC 110 generates the audio signals that can be heard at the positions of Players 1, 2 appearing in the same scene, respectively, and multicasts or broadcasts them. In FIG. 15, the positions of Players 1, 2 with respect to Monster and the body orientations of Players 1, 2 are different from each other, and thus the volume of the footsteps of Monster creeping from behind and the orientations thereof are differently heard at Channels 1, 2. Thus, in a game involving a plurality of users, when each of the users wearing the wireless earphones 81, 82 selects Player that he or she wants to experience from among Player 1 or Player 2, he or she can hear a different specific position audio, which can provide the users with increased sense of immersion in the game.

According to the present embodiment, sound source signals collected based on a 3D sound source are added to a single video signal, and the TV 10 or the PC 110 generate audio signals each having different position and localization and multicast or broadcast them. This enables a plurality of users to view the same video while listening to audios of different positions in the same video, respectively.

In the TV coordination system 100k, the TV 10 is used as a monitor of the PC 110, however, the same advantageous operations and effects can be obtained if a display of a PC without including the TV tuner 12 is used as the TV 10. In this case, the function of multicasting or broadcasting may be implemented in the PC 110.

Furthermore, in the embodiments described above, the same advantageous operations and effects can be obtained in the configuration in which a monitor and a microphone are connected to the PC 110 equipped with a television tuner if it needs to receive a broadcast.

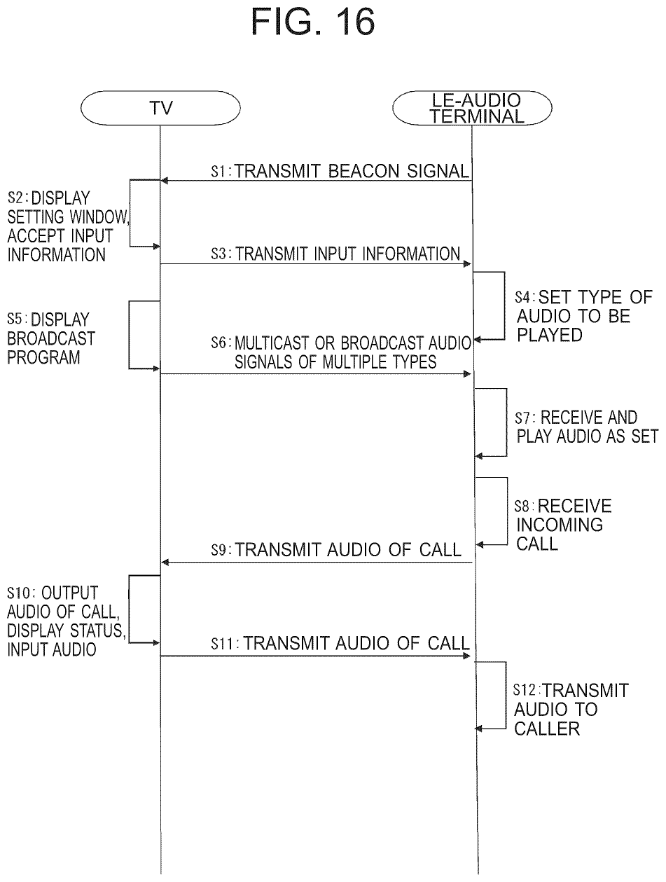

FIG. 16 is a sequence diagram illustrating a flow of the processing by the TV coordination system 100 according to the embodiments described above.

In the TV coordination system 100, an LE-Audio terminal, for example, the smartphone 51 multicasts or broadcasts a beacon signal (step S1), and the TV 10 receives the beacon signal.

The TV 10 displays the setting window 130 to accept input information to be entered in accordance with the setting window (step S2), and transmits the input information (step S3). The LE-Audio terminal sets the type of an audio to be played based on the input information as received (step S4). The LE-Audio terminal stands by in this state.

The TV 10 receives a broadcast signal and starts displaying a broadcast program (step S5), and then causes the Bluetooth communication unit 18 to multicast or broadcast a plurality of audio signals of the broadcast program (step S6: step of transmitting).

The LE-Audio terminal receives the audio signals transmitted by multicasting or broadcasting and plays them (step S7: steps of receiving and playing).

The TV 10 receives a broadcast signal and starts displaying a broadcast program (step S5), and then causes the Bluetooth communication unit 18 to multicast or broadcast a plurality of audio signals of the broadcast program (step S6).

Upon receiving an incoming call (step S8), the LE-Audio terminal multicasts or broadcasts an audio of the call (step S9). Upon receiving the audio of the call, the TV 10 outputs it and displays the status, and also accepts an audio input through the microphone 21 (step S10). The TV 10 multicasts or broadcasts the audio input through the microphone 21 (step S11), and transmits the audio through the LE-Audio terminal to the destination of the call (step S12).

Although not illustrated in FIG. 16, the TV 10 is also connected to the home hub IoT devices 191, 192, 193, and transmits signals from the home hub IoT devices 191, 192, 193 to the LE-Audio terminal.

In the above, the embodiments of the present invention have been described, and of course, the configurations for implementing the technical features according to the present invention are not limited to those described in these embodiments and various modifications can be made.

For example, a part of the configuration of an embodiment may be replaced with the configuration of a further embodiment, and the configuration of an embodiment may include the configuration of a further embodiment. All of these are included in the scope of the present invention, and the numerical values and messages appearing in the text and drawings are merely examples. Accordingly, the advantageous effects of the present invention are not impaired even if different ones are used.

For example, in the embodiments described above, a transmission condition for transmitting a multicast or broadcast signal may be set in the TV 10. The TV 10 may be controlled to start transmitting a multicast or broadcast signal when receiving a Bluetooth beacon and confirming the presence of a registered device, but not to transmit the multicast or broadcast signal when cannot confirm the presence of a registered device (in absence of Bluetooth communication). Suppressing unnecessary transmission can reduce the power consumption and also prevent radio wave interferences of Bluetooth signals.

Each of the programs described in the examples of the processing may be an independent program, or a plurality of programs configuring one application program. Furthermore, the orders of executing the processes may be changed.

Some or all the functions and the like of the present invention described above may be implemented by hardware, for example, by designing them with an integrated circuit.

Furthermore, a microcontroller unit or the like may interpret and execute an operation program so that some or all the functions and the like of the present invention can be implemented by software. Hardware and software may be used in combination.

The control lines and information lines which are considered to be necessary for the purpose of explanation are indicated herein, but not all the control lines and information lines of actual products are necessarily indicated. It may be considered that almost all the components are actually connected to each other.

### REFERENCE SIGNS LIST

10: TV
11: controller
11a: processor
11b: calendar clock
11c: timer
12: TV tuner
13: display
14: memory
14a: work area
14b: storage area
15: video and audio communication unit
16: wired LAN communication unit
17: wireless LAN communication unit
18: Bluetooth communication unit
19: external device connection unit
20: built-in speaker
21: microphone
30: remote controller
41: doorbell
50, 50a, 50b: smart speaker
51: smartphone
61: call status display
64: new device notification
65: playback necessity button
81, 82: wireless earphones
100, 100a, 100b, 100c, 100d, 100e, 100f, 100g, 100h, 100i,
100j, 100k: TV coordination system
130: setting window
130a: registration field
131: setting screen
190: home hub
191, 192, 193: home IoT device

1. A display device for directly transmitting and receiving an audio signal to and from an audio signal receiving device by wireless communication without causing the audio signal to pass through a relay device, comprising:
a wireless communication unit;
a display; and
a controller configured to control the wireless communication unit and the display, wherein
the wireless communication unit transmits a plurality of types of audio signals by multicast or broadcast wireless communication, and
the plurality of types of audio signals is provided with incidental information indicating at least types of the audio signals, respectively.

2. The display device according to claim 1, wherein
the incidental information is information relating to a type of language included in a multilingual broadcast signal, channel name information of each of a plurality of broadcast programs when the plurality of broadcast programs is simultaneously displayed, or information indicating an audio playback position when a 3D sound source is used.

3. The display device according to claim 1, wherein
the display device is connected to at least one of a doorbell, household equipment, or home electric appliance,
the controller displays a notification indicating a content of a detection signal of the doorbell, that of a detection signal of the household equipment, or that of a detection signal of the home electric appliance on the display, and
the wireless communication unit transmits the detection signal of the doorbell, the detection signal of the household equipment, or the detection signal of the home electric appliance by the multicast or broadcast wireless communication.

4. The display device according to claim 1, further comprising:
a built-in speaker; and
a microphone, wherein
the controller further controls the built-in speaker and the microphone,
the microphone collects an audio played by the audio signal receiving device based on the audio signal wirelessly transmitted by multicasting or broadcasting from the wireless communication unit, and
the controller is configured to:
measure a delay time between a timing at which the microphone collected the audio and a time at which the wireless communication unit transmitted the audio signal; and
adjust an audio output timing from the built-in speaker based on the delay time so as to bring an output timing of the audio signal from the built-in speaker close to a timing at which the audio signal receiving device receives and plays the audio signal.

5. The display device according to claim 4, wherein the controller adjusts a timing of displaying a video on the display based on the delay time so as to synchronize the video to be displayed on the display with the timing at which the audio signal receiving device receives and plays the audio signal.

6. The display device according to claim 1, further comprising a built-in speaker, wherein
the controller further controls the built-in speaker,
the wireless communication unit interactively communicates with the audio signal receiving device, and receives an audio signal wirelessly transmitted by multicasting or broadcasting from the audio signal receiving device, and
the controller outputs the audio signal as received through the built-in speaker and also displays a status indicating that the audio signal wirelessly transmitted from the audio signal receiving device is being played on the display.

7. The display device according to claim 1, further comprising:
a microphone; and
a built-in speaker, wherein
the controller further controls the microphone and the built-in speaker,
the wireless communication unit interactively communicates with the audio signal receiving device, the microphone collects an audio played by the audio signal receiving device based on the audio signal wirelessly transmitted by multicasting or broadcasting from the wireless communication unit, and
the controller detects a direction of the audio signal receiving device relative to the display device based on the audio collected by the microphone, and control, when outputting an audio received from the audio signal receiving device through the built-in speaker, a localization of the audio.

8. The display device according to claim 1, further comprising an operation member for inputting an operation to the display, wherein
the wireless communication unit interactively communicates with the audio signal receiving device, and
the controller displays a setting window for setting a type of an audio signal to be played by the audio signal receiving device on the display, and
upon accepting input information entered in accordance with the setting window from the operation member, the wireless communication unit transmits the input information to the audio signal receiving device.

9. The display device according to claim 1, further comprising an operation member for inputting an operation to the display, wherein
the wireless communication unit interactively communicates with the audio signal receiving device, and
when the wireless communication unit receives, from the audio signal receiving device, a signal indicating that the audio signal receiving device has received a wireless signal by multicasting or broadcasting from a new external device, the controller displays a setting window for setting whether to allow the audio signal receiving device to communicate with the new external device on the display, and
upon accepting input information entered in accordance with the setting window from the operation member, the wireless communication unit transmits the input information to the audio signal receiving device.

10. The display device according to claim 1, wherein
the controller displays a plurality of programs side by side within a screen of the display, and
the wireless communication unit transmits audio signals of the plurality of programs by multicast or broadcast wireless communication, respectively.

11. The display device according to claim 1, wherein
the controller generates, based on 3D sound source information, specific position audio signals that can be heard at a plurality of positions within a displayed image, respectively, and
the wireless communication unit transmits the plurality of specific position audio signals generated for the plurality of positions, respectively, by multicast or broadcast wireless communication.

12. A display device coordination system comprising:
a display device; and
an audio signal receiving device,
the display device and the audio signal receiving device being connected to each other by wireless communication, wherein
the display device includes:
a first wireless communication unit configured to directly transmit an audio signal to the audio signal receiving device without causing the audio signal to pass through a relay device;
a display; and
a controller configured to control the first wireless communication unit and the display,
the audio signal receiving device includes:
a second wireless communication unit configured to directly receive the audio signal from the display device without causing the audio signal to pass through a relay device, and
an audio playback unit configured to play the audio received by the second wireless communication unit,
the first wireless communication unit transmits a plurality of types of audio signals by multicast or broadcast wireless communication,
the plurality of types of audio signals includes incidental information indicating names of transmission devices that have transmitted the audio signals and types of the audio signals, respectively, and
the audio playback unit plays an audio signal of a preset type among the plurality of types of audio signals received by the second wireless communication unit.

13. An audio playback method to be executed by a display device and an audio signal receiving device which are connected to each other by wireless communication, comprising the steps of:
by the display device, transmitting a plurality of types of audio signals by multicast or broadcast wireless communication;
by the audio signal receiving device, receiving the plurality of types of audio signals; and
by the audio signal receiving device, playing one of the plurality of types of audio signals, wherein
the plurality of types of audio signals includes incidental information indicating types of the audio signals, respectively, and
in the step of playing, an audio signal of a type set in advance in the audio signal receiving device is played.
